(19) United States
(12) Patent Application Publication
(10) Pub. No.: US 2023/0306268 A1
(43) Pub. Date: Sep. 28, 2023

(54) ZERO-SHOT CLASSIFICATION OF MEASUREMENT DATA

(71) Applicant: Robert Bosch GmbH, Stuttgart (DE)

(72) Inventors: Daria Stepanova, Leonberg (DE); Trung Kien Tran, Stuttgart (DE); Youmna Salah Mahmoud Ismaeil, Stuttgart (DE); Csaba Domokos, Simmozheim (DE); Piyapat Saranrittichai, Nuernberg (DE)

(21) Appl. No.: 18/173,559

(22) Filed: Feb. 23, 2023

(30) Foreign Application Priority Data
Mar. 25, 2022 (DE) 10 2022 202 985.2

(51) Int. Cl. G06N 3/091; G06N 3/063; G06F 18/2415

(52) U.S. Cl. CPC G06N 3/091; G06N 3/063; G06F 18/2415

(57) ABSTRACT

A method for operating at least one trained classifier for measurement data. The classifier comprises a neural network with at least one feature extraction section and at least one classification section. The method includes: processing a record of measurement data with at least the feature extraction section of the classifier; determining a set of neurons in the feature extraction section that are activated by said processing; determining, from a given correspondence between activated neurons and attributes, a set of attributes whose presence in a scene captured by the measurement data is indicated by the activated neurons; comparing attributes to which classes are linked by a given knowledge graph with said determined set of attributes; and evaluating, from the result of this comparison, at least one estimated class as a class to which the scene captured by the record of measurement data is likely to belong.

### CROSS REFERENCE

The present application claims the benefit under 35 U.S.C. § 119 of German Patent Application No. DE 10 2022 202 985.2 filed on Mar. 25, 2022, which is expressly incorporated herein by reference in its entirety.

### FIELD

The present invention relates to the classification of measurement data, and in particular images, with respect to their semantic content.

### BACKGROUND INFORMATION

Classifiers for measurement data take records of measurement data as input and map them to classification scores with respect to at least one class out of a given set of classes. They are usually trained in a supervised manner with training samples that are labelled with “ground truth” classification scores. Parameters that characterize the behavior of the classifier are optimized such that, when the training samples are processed by the classifier, the classifier maps these training samples to their corresponding ground truth classification scores.

During training, the classifier only sees training samples that, according to their “ground truth” classification scores, belong to a finite set of classes. A popular task in the field of classifying measurement data is classifying, using a given trained classifier, measurement data also with respect to classes that the classifier has not seen during its training. This task is called “zero-shot classification”.

### SUMMARY

The present invention provides a method for operating at least one trained classifier for measurement data. In particular, the measurement data may represent physical quantities captured by any suitable physical sensor. For example, the measurement data may comprise at least one image, and/or at least one point cloud. An image is an arrangement of points in a regular grid in two- or three-dimensional space that carry measurement values, such as intensities of light or ultrasound emitted from an area of interest. For example, still cameras, video cameras, thermal cameras, and ultrasound apparatuses produce images. A point cloud is an arrangement of points that also carry measurement values, but are not necessarily arranged in a regular grid. For example, if an area is probed with radar or lidar radiation, points in space at which radiation is reflected back to the sensor are collected in a point cloud.

The classifier comprises a neural network with at least one feature extraction section and at least one classification section. The purpose of the feature extraction section is to reduce the high dimensionality of the input measurement data and produce quantities that are indicative of the presence of certain features. To this end, the feature extraction section may, in particular, comprise one or more convolutional layers that apply one or more filter kernels to their input in a sliding manner. The feature extraction section comprises neurons whose activations indicate the presence of certain features in the measurement data. The classification section is configured to compute a classification score with respect to at least one class out of a given set of classes from the output of the feature extraction section.

According to an example embodiment of the present invention, in the course of the method, a record of measurement data is processed with at least the feature extraction section of the classifier. A set of neurons in the feature extraction section that are activated by said processing is then determined.

From a given correspondence between activated neurons and attributes, a set of attributes whose presence in a scene captured by the measurement data is indicated by the activated neurons is determined. In a simple example, activation of one neuron may correspond to the presence of one attribute. But it is also possible that activation patterns comprising multiple neurons are indicative of the presence of particular attributes. The correspondence between a particular activated neuron on the one hand and an attribute on the other hand may be binary in the sense that it is either present or not, but this is not required. Rather, correspondences may be labelled with weights or degrees that encode how strongly the neuron activation and the presence of the attribute are correlated.

For example, if the measurement data comprises images and/or point clouds gathered by observation of an area of interest with one or more sensors, the attributes may correspond to objects present in the scene captured in the image and/or point cloud, such as paintings, table, sink, bath, towel or treadmill.

This determined set of attributes is compared with attributes to which classes are linked by a given knowledge graph. This knowledge graph may define any kind of relationships between classes and attributes.

In the mentioned example where the measurement data comprises images and/or point clouds, the classes may correspond to the type of room that the image shows, such as art studio, kitchen, bathroom or gym. An art studio has both paintings and tables. A kitchen has both tables and sinks. A bathroom has sinks, a bath, and towels. A gym has treadmills and towels.

Thus, in a particularly advantageous embodiment of the present invention, the relationships between classes and attributes in the knowledge graph may comprise:
a relationship that an entity corresponding to a class has and/or comprises an entity corresponding to an attribute; and/or
a relationship that an entity corresponding to a class is also an entity corresponding to an attribute.

With commonsense knowledge graphs of this kind that describe visual and physical properties of object classes, the behavior of neurons may be explained in human-interpretable terms.

From the result of the comparison between attributes in the knowledge graph and attributes determined from active neurons, at least one estimated class as a class to which the scene captured by the record of measurement data is likely to belong. For this, all classes in the given knowledge graph are available. These classes can comprise classes that the given classifier has not seen during its training.

By determining an estimated class in this manner, the given classifier can be put to use to solve said zero-shot classification problem. That is, the classifier may predict that a record of measurement data, such as an image, belongs to a particular class even though the classifier has not seen this class during training. In essence, this extends the functionality of the given classifier.

According to an example embodiment of the present invention, the classifier could also be made to recognize new classes by means of a re-training comprising also the new classes, or a further training specifically on the new classes starting from its previously trained state. Extending the functionality of the classifier through zero-shot classification does not require any further training of the given classifier, and therefore does not require any additional training samples. The main prerequisites for extending the functionality to a new class are that
the new class is comprised in the knowledge graph,
the knowledge graph links this new class to at least one attribute, in particular to an attribute of an already seen class, and
the given correspondence links this attribute to an activated neuron, and/or to a pattern of activated neurons.

For example, if the classifier was trained to distinguish between kitchens and bathrooms, and it shall now also recognize art studios and gyms, art studios and gym need to be comprised in the knowledge graph and connected to suitable attributes. The new classes and their connections to suitable attributes may already be comprised in the existing knowledge graph, but they may also be added to a knowledge graph with little effort. In particular, if the attributes that are already in the knowledge graph for an already seen class also apply to the new unseen class but are not yet connected to it, connections between these attributes and the new classes should be added to the knowledge graph. In the example of a classifier that is presently trained to distinguish between kitchens and bathrooms, the knowledge graph already comprises a table as an attribute because a table is typical for a kitchen. But tables are found in art studios as well, so it is appropriate to connect the table to the art studio if this connection is not yet present. Likewise, the knowledge graph already comprises a towel because towels are found in bathrooms. But towels are also found in gyms, so the towel should be linked to the gym if it is not already linked to the gym.

It is then advantageous, but optional, to introduce further attributes, and/or connections between existing attributes and the new classes, that allow for disambiguation. For example, if a treadmill is present, then it can be directly inferred that the room is a gym. Likewise, if paintings are present, it can be directly inferred that the room is an art studio because it makes no sense to place them in kitchens, bathrooms or gyms. But some disambiguation is also possible, e.g., based on attributes that the record of measurement data is lacking.

For example, if a towel is present in an image, but neither a sink or bath is present, then the chance is high that the room is a gym, rather than a bathroom that needs a bath and a sink. Likewise, if a table is present, but a sink and other attributes that point to the room being a kitchen are missing, the chance is high that the room is an art studio.

According to the method according to an example embodiment of the present invention, the functionality of zero-shot classification is “piggy-backed” onto the classifier without having to change the behavior of the classifier or its training. Even when starting from a situation where only the trained classifier is present, but there is no correspondence between activated neurons and attributes yet, and there is also no knowledge graph yet, the correspondence and the knowledge graph may be easily obtained. Any suitable records of measurement data showing attributes of the knowledge graph may be used to determine the correspondence between activated neurons and attributes. The knowledge graph itself can be set up even without using the given classifier. The knowledge graph is also independent from the classifier; that is, one and the same knowledge graph may be used with many different classifiers.

Not having to touch the classifier is particularly advantageous for high-risk applications such as at least partially automated driving of vehicles, where the correct functioning of classifiers needs to be officially certified. All previous functionality for previous classes will still continue to work, so by adding the capability to detect new classes, the hard-earned certification will not be invalidated.

To this end, in a particularly advantageous embodiment of the present invention, it is evaluated, from the output delivered by the classifier after processing the record of measurement data, whether the scene captured by the record of measurement data belongs to a class seen by the classifier during its training. If it is determined that the scene belongs to a seen class, the class to which the scene most likely belongs is determined from the output of the classification section of the classifier. That is, for seen classes, the classifier will behave exactly as before. However, if it is determined that the scene belongs to an unseen class, the class to which the scene most likely belongs is determined to be the estimated class determined as described above. In any case, this is closer to the correct classification than just choosing the best out of the seen classes, i.e., the “best” solution among all incorrect solutions.

This possibility can already be provided for during training of the classifier. In a further particularly advantageous embodiment of the present invention, the classifier is trained to compute an additional classification score for the case that the scene captured by the record of measurement data belongs to an unseen class. That is, on top of the classification scores for various concrete classes seen during the training, there is another class “None of the above” for measurement data of unseen classes. Any kind of unseen measurement data may be used as training material for this additional class. For example, this unseen measurement data may belong to classes that are not in the catalogue of concrete classes that the classifier is being trained to identify.

In a further advantageous embodiment of the present invention, it is evaluated from the classification scores outputted by the classifier for the seen classes whether the scene captured by the record of measurement data belongs to a seen class. For example, if the classification scores with respect to all seen classes are all below a certain threshold, it may be inferred that none of the seen classes is really appropriate and the classifier is outputting the “best” solution among all incorrect solutions.

In a further advantageous embodiment of the present invention, from at least one attribute in the set of determined attributes, a portion of the record of measurement data that has given rise to this attribute is evaluated. For example, if the record of measurement data comprises an image, said portion may correspond to an image region. The so-determined portion of the record of measurement data may then be determined to be salient for the decision of the classifier. That is, irrespective of whether the record of measurement data belongs to a seen class or to an unseen class, it may be determined on which portions of the record of measurement data the classifier bases its decision. This is important for the explainability of the classifier.

In a particularly advantageous embodiment of the present invention, neurons in a fully connected layer of the feature extraction section are examined as to whether they are activated by said processing of the record of measurement data. For example, if the measurement data comprises an image, neurons in fully connected layers reflect high level abstract visual features.

In a particularly advantageous embodiment of the present invention, a neuron is determined as an activated neuron in response to its activation value exceeding a predetermined threshold value. The activation value may, for example, comprise a weighted sum of inputs to the neuron. The weights for these weighted sums are parameters that are optimized during the training of the classifier. A nonlinear activation function is applied to the activation value, so that the final output value of the neuron is obtained.

In a particularly advantageous embodiment of the present invention, the knowledge graph is chosen to comprise a superset of the classes that the classifier has seen during its training. In this manner, newly introduces attributes may be optimally used to disambiguate between seen and unseen classes, and also among unseen classes.

In a further particularly advantageous embodiment of the present invention, a likelihood that that the scene captured by the record of measurement data belongs to a class is determined based on how many of the attributes linked to this class by the knowledge graph are in the determined set of attributes. In particular, for a determined set of attributes and a prospective class, the likelihood may be determined by dividing the number of attributes that are linked to the prospective class and comprised in the determined set of attributes by the total number of attributes that are linked to the prospective class. This will yield a likelihood between 0 and 1.

In a further particularly advantageous embodiment of the present invention, for multiple classes, likelihoods that the scene captured by the record of measurement data belongs to the respective class are determined. The multiple classes are then ranked according to these likelihoods. This provides an organic way to determine the class that most likely fits the determined attributes.

In a further particularly advantageous embodiment of the present invention, the record of measurement data is processed with feature extraction sections of multiple classifiers. The sets of attributes whose presence in the scene captured by the record of measurement data is indicated by the activated neurons of the multiple classifiers are pooled. That is, all the attributes discovered using all classifiers are compared with attributes linked to classes by the given knowledge graph. In this manner, knowledge learned by the multiple classifiers may be put together without touching the internals of any of these classifiers.

The ultimate purpose of the zero-shot classification is to obtain an assignment of the record of measurement data to a class that is more likely to be appropriate in the context of the application at hand. This can be used in the context of that application for an improved automated control of technical systems. Therefore, in a further particularly advantageous embodiment, an actuation signal is computed from the class to which the scene captured by the record of measurement data most likely belongs. A vehicle, a system for quality inspection, a surveillance system, and/or a medical imaging system, with the actuation signal. In this manner, the reaction that the respective technical system will then perform is likely to be more appropriate in the context of the scene captured in the record of measurement data.

The method may be wholly or partially computer-implemented, and can therefore be embodied in software. The present invention therefore also provides computer program, comprising machine-readable instructions that, when executed on one or more computers and/or compute instances, cause the one more computers and/or compute instances to perform the method(s) described above. In particular, control devices for vehicles, process controllers, microcontrollers and other electronic devices that are able to execute machine-readable instructions may be regarded as computers as well. Compute instances comprise virtual machines, containers and any other execution environments in which machine-readable instructions may be executed. The present invention also relates to a machine-readable data carrier, and/or a download product, with the computer program. A download product is a product that may be sold in an online shop for immediate fulfillment by download. The present invention also provides one or more computers and/or compute instances with the one or more computer programs, and/or with the one or more machine-readable data carriers and/or download products.

In the following, the present invention is illustrated using Figures without any intention to limit the scope of the present invention.

### BRIEF DESCRIPTION OF THE DRAWINGS

FIG. 1 shows an exemplary embodiment of the method 100 for operating a trained classifier 1, according to the present invention.

FIG. 2 shows an illustration of how an estimated class 7# may be obtained based on activated neurons 4 in the feature extraction section 3a of the classifier 1, according to an example embodiment of the present invention.

### DETAILED DESCRIPTION OF EXAMPLE EMBODIMENTS

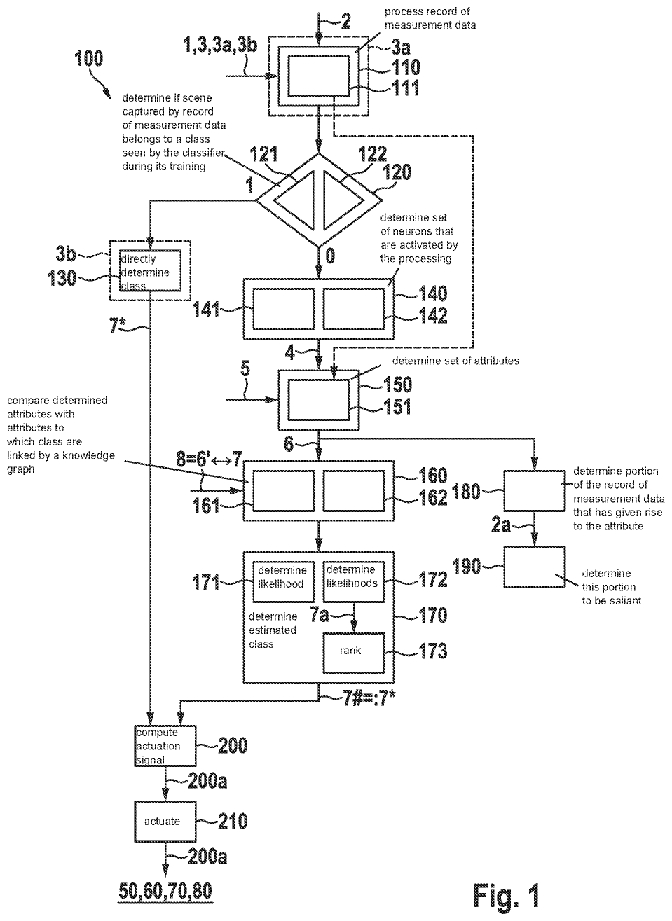

FIG. 1 is a schematic flow chart of an embodiment of the method 100 for operating a trained classifier 100. The trained classifier 1 comprises a neural network 3 with at least one feature extraction section 3a and at least one classification section 3b.

In step 110, a record of measurement data 2 is processed with at least the feature extraction section 3a of the classifier 1.

In step 120, from the output delivered by the classifier 1 after processing the record of measurement data 2, it is determined whether the scene captured by the record of measurement data 2 belongs to a class 7 seen by the classifier 1 during its training. If this is the case (truth value 1), in step 130, the class 7* to which the scene most likely belongs is directly determined from the output of the classification section 3b of the classifier 1.

However, if the scene belongs to an unseen class (truth value 0), an estimated class 7# determined based on activated neurons 4 in the feature extraction section 3a of the classifier 1 is determined as the class 7* to which the scene most likely belongs. The derivation of the estimated class 7# is detailed in the following.

In step 140, a set of neurons 4 in the feature extraction section that are activated by the processing of the record of measurement data 2 is determined.

In step 150, from a given correspondence 5 between activated neurons 4 and attributes 6, a set of attributes 6 is determined. That is, the activated neurons 4 indicate the presence of these attributes 6 in a scene captured by the measurement data 2.

In step 160, these determined attributes 6 are compared with attributes 6′ to which classes 7 are linked by a given knowledge graph 8.

In step 170, from the result of this comparison, at least one estimated class 7# is determined. This estimated class 7# is a class to which the scene captured by the record of measurement data 2 is likely to belong. In principle, this estimated class 7# may always be used as a class 7* to which the scene most likely belongs. In the example shown in FIG. 1, it is analyzed whether the scene belongs to a seen or unseen class. In this example, the estimated class 7# is used as the class 7* to which the scene most likely belongs only for records of measurement data 2 of unseen classes, so as not to change the behavior of the classifier 1 regarding seen classes.

Irrespective of which path was followed to arrive at the class 7* to which the scene captured by the record of measurement data 2 most likely belongs, in step 200, from this class 7*, an actuation signal 200a may be computed. In step 210, a vehicle 50, a system 60 for quality inspection, a surveillance system 70, and/or a medical imaging system 80, may be actuated with the actuation signal 200a.

Furthermore, irrespective of how the most likely class 7* was determined, in step 180, from at least one attributed in the set of determined attributes 6, a portion 2a of the record of measurement data 2 that has given rise to this attribute may be determined. In step 190, this portion 2a of the record of measurement data 2, such as an image region, may be determined to be salient for the decision of the classifier 1. That is, even for seen classes that can be evaluated normally, the evaluation of activated neurons in the feature extraction section 3a may yield useful information.

According to block 111, the record of measurement data 2 may be processed with feature extraction sections 3a of multiple classifiers 1. According to block 151, the sets of attributes 6 whose presence in the scene captured by the record of measurement data 2 is indicated by the activated neurons 4 of the multiple classifiers 1 may then be pooled.

According to block 121, the classifier 1 may be trained to compute an additional classification score for the case that the scene captured by the record of measurement data 2 belongs to an unseen class 7. For a given record of measurement data 2, it may then easily be determined whether it belongs to a seen or unseen class 7, so as to decide how to arrive at the most likely class 7*.

Alternatively or in combination, according to block 122, it may be evaluated from the classification scores outputted by the classifier 1 for the seen classes 7 whether the scene captured by the record of measurement data 2 belongs to a seen class 7.

According to block 141, neurons in a fully connected layer of the feature extraction section 3a may be chosen to be examined as to whether they are activated by the processing of the record of measurement data 2.

According to block 142, a neuron may be determined as an activated neuron 4 in response to its activation value exceeding a predetermined threshold value.

According to block 161, the relationships between classes 7 and attributes 6′ in the knowledge graph 8 may comprise:
a relationship that an entity corresponding to a class 7 has and/or comprises an entity corresponding to an attribute 6′. For example, a bathroom has a sink and also has towels; and/or
a relationship that an entity corresponding to a class 7 is also an entity corresponding to an attribute 6′. For example, a car is also a vehicle.

According to block 162, the knowledge graph 8 may be chosen to comprise a superset of the classes 7 that the classifier has seen during its training.

According to block 171, a likelihood 7a that the scene captured by the record of measurement data 2 belongs to a class 7 may be determined based on how many of the attributes 6′ linked to this class 7 by the knowledge graph 8 are in the determined set of attributes 6.

According to block 172, for multiple classes 7, likelihoods 7a that the scene captured by the record of measurement data 2 belongs to the respective class 7 may be determined. According to block 173, the multiple classes 7 may then be ranked according to these likelihoods.

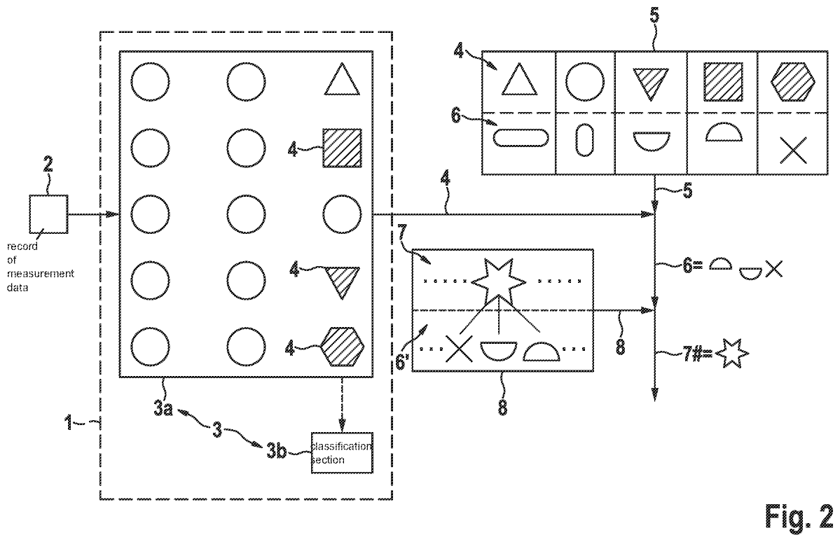

FIG. 2 illustrates how an estimated class 7# may be obtained based on activated neurons 4 in the feature extraction section 3a of the classifier 1, given a correspondence 5 between activated neurons 4 and attributes 6 on the one hand, and a knowledge graph 8 that links classes 7 to attributes 6′ on the other hand.

In the example shown in FIG. 2, the feature extraction section 3a of the classifier 1 comprises, from left to right, three layers of neurons. The usual way to determine a class 7 to which the scene captured by the record of measurement data 2 most likely belongs is to feed the output of the feature extraction section 3a into the classification section 3b of the classifier 1. As discussed before, this may still be done for scenes belonging to classes 7 that the classifier 1 has seen during its training.

For unseen classes, based on the activated neurons 4 (shown shaded in FIG. 2), corresponding attributes 6 are looked up in the given correspondence 5. In the simple example shown in FIG. 2, the correspondence is one-to-one, but this is not required. As discussed before, attributes 6 may also correspond to arbitrary patterns of multiple activated neurons 4.

The knowledge graph 8 connects each class 7 to one or more attributes 6′. That is, if these attributes 6′ are present in combination, the chance is high that the scene captured by the measurement data 2 belongs to the class 7 that corresponds to this combination of attributes 6′. In the example shown in FIG. 2, the attribute combination derived from the activated neurons 4 is found in the knowledge graph 8, and the corresponding class 7 is determined as the estimated class 7# to which the scene likely belongs.

What is claimed is:

1. A method for operating at least one trained classifier for measurement data, the classifier including a neural network with at least one feature extraction section and at least one classification section, wherein activations of neurons in the feature extraction section indicate presence of features in the measurement data and the classification section is configured to compute a classification score with respect to at least one class out of a given set of classes from output of the feature extraction section, the method comprising the following steps:
processing a record of measurement data with at least the feature extraction section of the classifier;
determining a set of neurons in the feature extraction section that are activated by the processing;
determining, from a given correspondence between the activated neurons and attributes, a set of the attributes whose presence in a scene captured by the measurement data is indicated by the activated neurons;
comparing attributes to which classes are linked by a given knowledge graph with the determined set of attributes; and
evaluating, from a result of the comparison, at least one estimated class as a class to which the scene captured by the record of measurement data is likely to belong.

2. The method of claim 1, further comprising:
evaluating, from output delivered by the classifier after processing the record of measurement data, whether the scene captured by the record of measurement data belongs to a class seen by the classifier during its training; and
in response to determining that the scene belongs to a seen class, determining the class to which the scene most likely belongs from the output of the classification section of the classifier; and
in response to determining that the scene belongs to an unseen class, determining the class to which the scene most likely belongs to be the estimated class.

3. The method of claim 2, wherein the classifier is trained to compute an additional classification score when the scene captured by the record of measurement data belongs to an unseen class.

4. The method of claim 2, wherein it is evaluated from classification scores output by the classifier for seen classes whether the scene captured by the record of measurement data belongs to a seen class.

5. The method of claim 1, further comprising:
evaluating, from at least one attribute in the set of determined attributes, a portion of the record of measurement data that has given rise to the at least one attribute; and
determining the portion of the record of measurement data to be salient for a decision of the classifier.

6. The method of claim 1, wherein neurons in a fully connected layer of the feature extraction section are examined as to whether they are activated by the processing.

7. The method of claim 1, wherein a neuron is determined as an activated neuron in response to its activation value exceeding a predetermined threshold value.

8. The method of claim 1, wherein relationships between classes and attributes in the knowledge graph include:
a relationship that an entity corresponding to a class has and/or includes an entity corresponding to an attribute; and/or
a relationship that an entity corresponding to a class is also an entity corresponding to an attribute.

9. The method of claim 1, wherein the knowledge graph includes superset of classes that the classifier has seen during its training.

10. The method of claim 1, wherein a likelihood that the scene captured by the record of measurement data belongs to a class is determined based on how many of the attributes linked to the class by the knowledge graph are in the determined set of attributes.

11. The method of claim 1, wherein:
for each respective class of multiple classes, likelihoods that the scene captured by the record of measurement data belongs to the respective class are determined; and
the multiple classes are ranked according to the likelihoods.

12. The method of claim 1, wherein the record of measurement data is processed with feature extraction sections of multiple classifiers, and the sets of attributes whose presence in the scene captured by the record of measurement data is indicated by the activated neurons of the multiple classifiers are pooled.

13. The method of claim 1, wherein the record of measurement data includes at least one image, and/or at least one point cloud.

14. The method of claim 1, further comprising:
computing, from the class to which the scene captured by the record of measurement data most likely belongs, an actuation signal; and
actuating a vehicle, and/or a system for quality inspection, and/or a surveillance system, and/or a medical imaging system, with the actuation signal.

15. A non-transitory machine-readable data carrier on which is stored a computer program including machine-readable instructions for operating at least one trained classifier for measurement data, the classifier including a neural network with at least one feature extraction section and at least one classification section, wherein activations of neurons in the feature extraction section indicate presence of features in the measurement data and the classification section is configured to compute a classification score with respect to at least one class out of a given set of classes from output of the feature extraction section, the instructions, when executed by one or more computers and/or compute instances, cause the one or more computers and/or compute instances to perform the following steps:
processing a record of measurement data with at least the feature extraction section of the classifier;
determining a set of neurons in the feature extraction section that are activated by the processing;
determining, from a given correspondence between the activated neurons and attributes, a set of the attributes whose presence in a scene captured by the measurement data is indicated by the activated neurons;
comparing attributes to which classes are linked by a given knowledge graph with the determined set of attributes; and
evaluating, from a result of the comparison, at least one estimated class as a class to which the scene captured by the record of measurement data is likely to belong.

16. One or more computers for operating at least one trained classifier for measurement data, the classifier including a neural network with at least one feature extraction section and at least one classification section, wherein activations of neurons in the feature extraction section indicate presence of features in the measurement data and the classification section is configured to compute a classification score with respect to at least one class out of a given set of classes from output of the feature extraction section, the one or more computers configured to:
process a record of measurement data with at least the feature extraction section of the classifier;
determine a set of neurons in the feature extraction section that are activated by the processing;
determine, from a given correspondence between the activated neurons and attributes, a set of the attributes whose presence in a scene captured by the measurement data is indicated by the activated neurons;
compare attributes to which classes are linked by a given knowledge graph with the determined set of attributes; and
evaluate, from a result of the comparison, at least one estimated class as a class to which the scene captured by the record of measurement data is likely to belong.
